(19) United States
(12) Patent Application Publication
(10) Pub. No.: US 2020/0310898 A1
(43) Pub. Date: Oct. 1, 2020

(54) INFORMATION PROCESSING METHOD AND INFORMATION PROCESSING APPARATUS

(71) Applicant: FUJITSU LIMITED, Kawasaki-shi, (JP)

(72) Inventors: Ai YANO, Kawasaki (JP); Takeshi Ohtani, Kawasaki (JP)

(73) Assignee: FUJITSU LIMITED, Kawasaki-shi (JP)

(21) Appl. No.: 16/812,002

(22) Filed: Mar. 6, 2020

(30) Foreign Application Priority Data
Mar. 27, 2019 (JP) 2019-061473

(51) Int. Cl. G06F 11/07; G06F 11/30

(52) U.S. Cl. CPC G06F 11/079; G06F 11/0793; G06F 11/3075; G06F 11/0781; G06F 11/0772

(57) ABSTRACT

An information processing method executed by a computer, the information processing method includes detecting abnormality occurrence based on information including operation management information related to performance of a management target apparatus collected from the management target apparatus, and estimating a failure type based on abnormality contents; analyzing the operation management information by using a parameter for analysis to specify a failure cause of the management target apparatus; determining whether a failure cause corresponding to the estimated failure type is specified or whether a failure type corresponding to the specified failure cause is estimated; and changing the parameter for analysis according to a priority order of a parameter corresponding to the estimated failure type or the specified failure cause when the failure cause corresponding to the estimated failure type is not specified or the failure type corresponding to the specified failure cause is not estimated as a result of the determination.

### CROSS-REFERENCE TO RELATED APPLICATION

This application is based upon and claims the benefit of priority of the prior Japanese Patent Application No. 2019-61473, filed on Mar. 27, 2019, the entire contents of which are incorporated herein by reference.

### FIELD

The embodiments discussed herein are related to an information processing method and an information processing apparatus.

### BACKGROUND

In recent years, with the expansion of Internet of Things (IoT), various types of devices are coupled to an information processing apparatus by various types of communication methods. In such a situation, failures (for example, a hardware failure or a software failure and a communication failure of a device) caused by a type of the coupled device, a communication method, a wireless state of the surroundings, and an application to be used may be varied. For this reason, in the IoT environment which changes momentarily, it is important to monitor hardware performance, software performance, communication performance, and the like of the device, to specify a failure cause, and to notify an operation manager of the failure cause.

When specifying the failure cause, operation management information (communication performance, terminal performance, or the like) or a measurement value (data) of a sensor (temperature and humidity or the like) is collected from the device or the network, the collected data is analyzed, and the failure cause is specified. The operation management information includes a reception signal strength (RSSI), a packet error rate (PER), a link quality, a response time, a retransmission count, a channel use rate, an active node count, and the like, as communication performance information. The operation management information includes a CPU use rate, a memory use rate, an HDD use rate, a battery remaining capacity, an internal temperature of the device, an internal processing time, and the like, as terminal performance information. A method of analyzing the data collected to specifying the failure cause includes a rule base (a method using a threshold value, a tree model or the like) or machine learning (correlation/regression/cycle characteristic analysis, clustering, a learning model, and the like). As the related art, for example, Japanese Laid-open Patent Publication No. 2009-147183, Japanese Laid-open Patent Publication No. 2013-065084, and the like are disclosed.

### SUMMARY

According to an aspect of the embodiments, an information processing method executed by a computer, the information processing method includes detecting abnormality occurrence based on information including operation management information related to performance of a management target apparatus periodically collected from the management target apparatus, and estimating a failure type based on abnormality contents; analyzing the operation management information by using a parameter for analysis to specify a failure cause of the management target apparatus; determining whether or not a failure cause corresponding to the estimated failure type is specified or whether or not a failure type corresponding to the specified failure cause is estimated; and changing the parameter for analysis according to a priority order of a parameter corresponding to the estimated failure type or the specified failure cause in a case where the failure cause corresponding to the estimated failure type is not specified or the failure type corresponding to the specified failure cause is not estimated as a result of the determination.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 schematically illustrates a configuration of an information processing system according to a first embodiment;

FIG. 2 is a diagram illustrating a hardware configuration of a gateway;

FIG. 3 is a functional block diagram of a sensor node, a gateway, and the like;

FIG. 4 is a diagram illustrating an operation management information DB;

FIG. 5 is a diagram illustrating a measurement value DB;

FIGS. 6A and 6B are diagrams for explaining a method of detecting abnormality occurrence;

FIG. 7 is a diagram illustrating an abnormality content and failure type correspondence table;

FIG. 8 is a diagram illustrating a parameter management DB;

FIG. 9 is a diagram illustrating an abnormality and failure cause specification correspondence table;

FIG. 10 is a diagram illustrating a failure type and failure cause correspondence table;

FIGS. 11A and 11B are flowcharts illustrating a process performed by a parameter change unit;

FIG. 12A is a diagram illustrating a change order for terminal; and FIG. 12B is a diagram illustrating a change order for communication;

FIG. 13 is a diagram illustrating an abnormality and failure cause specification correspondence table according to a second embodiment;

FIG. 14A is a diagram illustrating a change order for terminal according to the second embodiment; and FIG. 14B is a diagram illustrating a change order for communication according to the second embodiment;

FIG. 15 is a diagram illustrating an abnormality content and failure type correspondence table according to a third embodiment; and

FIG. 16 is a diagram illustrating an effect management table according to a fourth embodiment.

### DESCRIPTION OF EMBODIMENTS

In the analysis method described above, a parameter for analysis and a learning model are generally required. The parameter for analysis is, for example, a threshold value, a significant difference, a window size, a window movement amount, and the like, and in the related art, a parameter for analysis is set by assuming a failure cause determined as data to be collected in advance. For example, in a case of the learning model, a label is attached to the collected data such as “normal time” or “occurrence of trouble A” when a certain failure A artificially occurs and the learning model is generated.

Meanwhile, in the field of IoT where the installation devices are various and the surrounding environment changes momentarily, such as the radio use situation, it is unclear what abnormality or failure occurs, so that there is a high possibility that determination accuracy is low when using the parameter for analysis set in advance. There is also a high possibility that the learning model generated in advance is not be used. In view of the above, it is desirable to automatically change the parameter for analysis used for specifying the failure cause, as required.

### First Embodiment

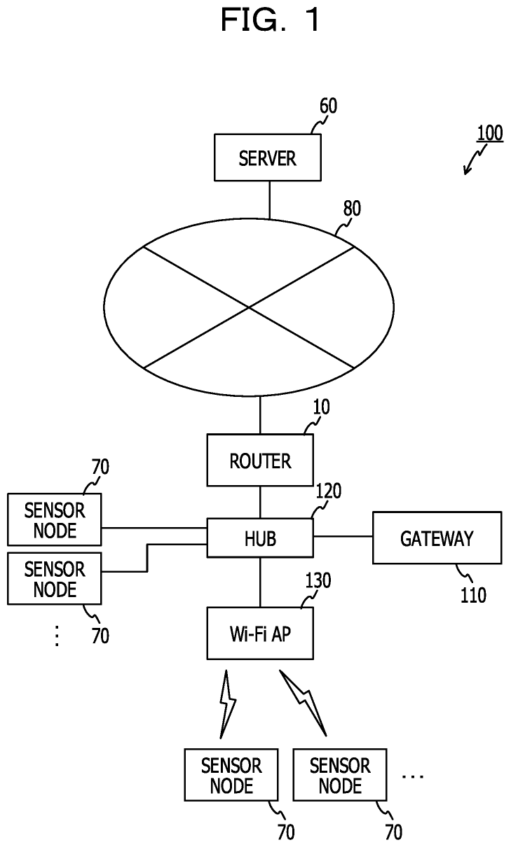

A first embodiment of an information processing system will be described in detail below with reference to FIGS. 1 to 12B.

FIG. 1 schematically illustrates a configuration of an information processing system 100 according to the first embodiment. The information processing system 100 includes a router 10 and a server 60 coupled to a network 80 such as the Internet, a Wi-Fi access point 130 and a sensor node 70 coupled to the router 10 via a hub 120 in a wired manner, a gateway 110 as an information processing apparatus, and another sensor node 70 capable of wirelessly communicating with the router 10 via the Wi-Fi access point 130 and the hub 120.

The server 60 is an apparatus which obtains and manages information transmitted from a plurality of gateways 110 existing over the network 80.

The sensor node 70 is an apparatus having a sensor and a data processing function and a communication function. For example, the sensor node 70 is installed in a manufacturing factory, measures a temperature, humidity, vibration, and the like, and transmits a measurement value to the gateway 110 by wired communication, or transmits the measurement value by wireless communication to the gateway 110 via the Wi-Fi access point 130. The sensor node 70 measures performance values indicating performance (hardware performance and software performance) of the sensor node 70 or communication quality between the gateway 110 and the sensor node.

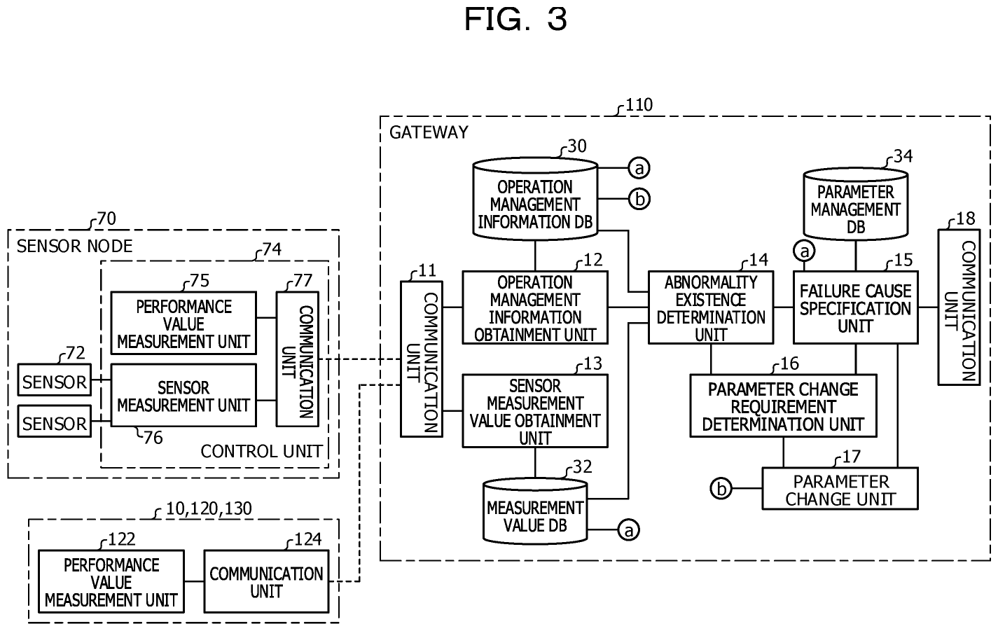

FIG. 3 illustrates a functional block diagram of the sensor node 70 and the gateway 110. FIG. 3 also illustrates a function of measuring performance values of the router 10, the hub 120, and the Wi-Fi access point 130.

(Sensor Node 70)

As illustrated in FIG. 3, the sensor node 70 includes one or a plurality of sensors 72 and a control unit 74.

The sensor 72 includes a sensor which measures temperature and humidity, a sensor which measures vibration, and the like.

The control unit 74 has functions of a performance value measurement unit 75, a sensor measurement unit 76, and a communication unit 77 by causing a central processing unit (CPU) to execute a program.

The performance value measurement unit 75 measures a value (a performance value) of performance data indicating performance of hardware or software of the sensor node 70 based on a sampling interval and an obtainment command notified from the gateway 110 (an operation management information obtainment unit 12) via the communication unit 77. The performance data indicating the performance of the hardware or software includes, for example, a CPU use rate, a memory use rate, a hard disk drive (HDD) use, a battery remaining capacity, an internal temperature of the sensor node, an internal processing time, and the like.

When receiving the command (the sampling command) for obtaining a value of performance data (a performance value) indicating communication performance from the gateway 110 (the operation management information obtainment unit 12), the performance value measurement unit 75 measures a performance value indicating the communication performance. The performance data indicating the communication performance includes a received signal strength indicator (RSSI), link quality (LQ), a packet error rate (PER), a bit error rate (BER), a response time, a retransmission count, a channel use rate, an active node count, and the like.

The sensor measurement unit 76 obtains the value measured by the sensor 72 (a sensor measurement value) in the sampling interval and the obtainment command notified from the gateway 110 (a sensor measurement value obtainment unit 13).

The performance value measurement unit 75 and the sensor measurement unit 76 collectively transmit untransmitted data via the communication unit 77 for each data transmission interval notified from the operation management information obtainment unit 12 or the sensor measurement value obtainment unit 13. When receiving the data request command from the operation management information obtainment unit 12 or the sensor measurement value obtainment unit 13, the performance value measurement unit 75 and the sensor measurement unit 76 may collectively transmit the untransmitted data to the gateway 110 via the communication unit 77.

The router 10, the hub 120, and the Wi-Fi access point 130 have functions as a performance value measurement unit 122 and a communication unit 124 by causing a CPU to execute a program. The performance value measurement unit 122 and the communication unit 124 are the same as those of the performance value measurement unit 75 and the communication unit 77 included in the sensor node 70. Therefore, the performance value measurement unit 122 measures a value (a performance value) of performance data of each apparatus, and transmits the value to the gateway 110 via the communication unit 124. The performance value of each apparatus includes performance values indicating performance (hardware performance and software performance) of the apparatus, and performance values indicating communication quality between the apparatus and other apparatuses.

(Gateway 110)

The gateway 110 is, for example, a network node installed in a manufacturing factory or the like. The gateway 110 receives performance values measured in the sensor node 70, the router 10, the hub 120, and the Wi-Fi access point 130, and sensor measurement values measured by the sensor node 70. The gateway 110 determines whether or not the sensor node 70 or the network is abnormal, based on the received information. For example, the sensor node 70, the router 10, the hub 120, and the Wi-Fi access point 130 may be regarded as management target apparatuses by the gateway 110. In a case where it is determined that an abnormality occurs, the gateway 110 estimates a failure type from abnormality contents, specifies a failure cause, and notifies the server 60 or a terminal (not illustrated) used by an operation manager of the failure cause. The gateway 110 changes a parameter for analysis used when specifying the failure cause, as required.

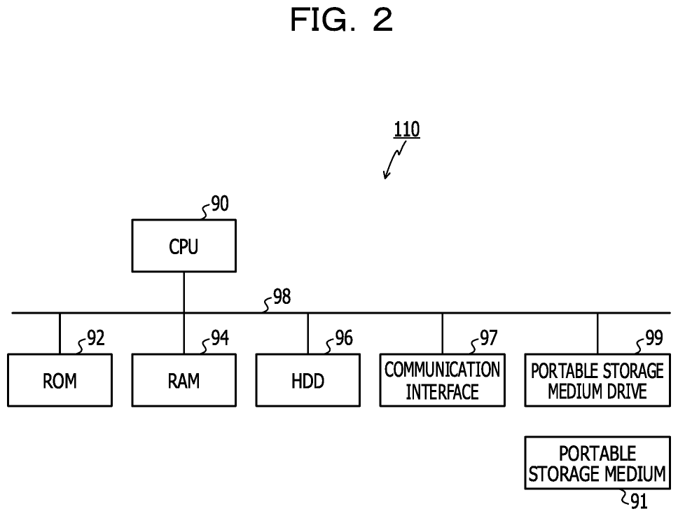

FIG. 2 illustrates a hardware configuration of the gateway 110. As illustrated in FIG. 2, the gateway 110 includes a CPU 90, a read-only memory (ROM) 92, a random-access memory (RAM) 94, a storage unit (here, HDD) 96, a communication interface 97, a portable storage medium drive 99, and the like. The component units of the gateway 110 are coupled to a bus 98. In the gateway 110, a function of each unit illustrated in FIG. 3 is realized by causing the CPU 90 to execute a program stored in the ROM 92 or the HDD 96 or a program read from the portable storage medium 91 by the portable storage medium drive 99. The function of each unit illustrated in FIG. 3 may be realized by an integrated circuit, such as an application specific integrated circuit (ASIC) or a field-programmable gate array (FPGA), for example.

As illustrated in FIG. 3, the gateway 110 functions as a communication unit 11, the operation management information obtainment unit 12, the sensor measurement value obtainment unit 13, an abnormality existence determination unit 14 as an estimation unit, a failure cause specification unit 15 as a specification unit, a parameter change requirement determination unit 16 as a determination unit, a parameter change unit 17 as a change unit, and a notification unit 18 by the CPU 90 executing a program. An operation management information DB 30, a measurement value DB 32, and a parameter management DB 34 illustrated in FIG. 3 are stored in the HDD 96 or the like. It is assumed that the gateway 110 receives and manages network design information transmitted periodically or irregularly from outside the network. The design information includes a device ID of each apparatus (device) included in the information processing system 100 or a device ID (a parent device ID) of a device to which each device is coupled, an installation position, a design range (an upper limit and a lower limit) of a design value of a received signal strength indicator (RSSI), and the like. The design information may include information on a design range other than the RSSI. For example, the design range other than the RSSI may include communication performance information (link quality (LQ), a packet error rate (PER), a bit error rate (BER), a response time, a retransmission count, a channel use rate, an active node count, and the like. The design range may include terminal performance information (a CPU use rate, a memory use rate, an HDD use rate, a battery remaining capacity, an internal temperature of the sensor node, an internal processing time) and the like.

The operation management information obtainment unit 12 obtains a performance value measured in each management target apparatuses (70, 10, 120, and 130), and stores the performance value in the operation management information DB 30 as operation management information. In a case of obtaining the performance value, the operation management information obtainment unit 12 notifies the sensor node 70 of a sampling interval (a measurement interval of the performance value) and the like via the communication unit 11. When various performance values measured in the sensor node 70 are transmitted in accordance with the notified sampling interval or the like, the operation management information obtainment unit 12 obtains the performance value and stores the performance value in the operation management information DB 30 as operation management information. In a case where the operation management information DB 30 is updated, the operation management information obtainment unit 12 notifies the abnormality existence determination unit 14 of the update of the operation management information DB 30.

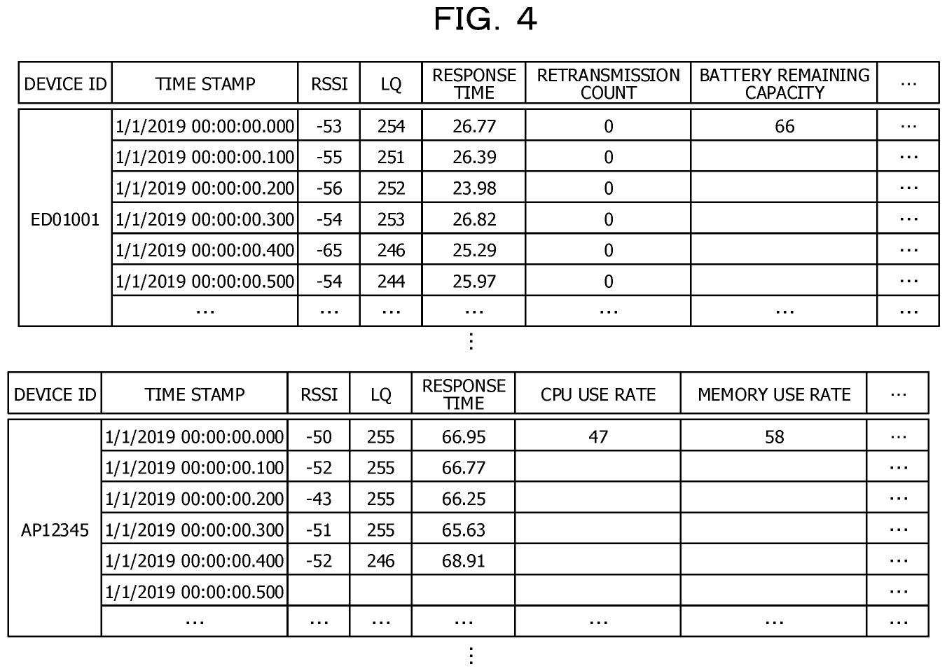

FIG. 4 illustrates a data structure of the operation management information DB 30. As illustrated in FIG. 4, the operation management information DB 30 manages “device ID”, “time stamp”, “RSSI”, “LQ”, “response time”, “retransmission count”, “battery remaining capacity”, and the like as operation management information for a certain end device (ED01001). The operation management information DB 30 manages “device ID”, “time stamp”, “RSSI”, “LQ”, “response time”, “CPU use rate”, “memory use rate”, and the like as operation management information for an access point (AP12345). The “device ID” is identification information of a device (the sensor node 70, the Wi-Fi access point 130, or the like) which is an obtainment destination of the operation management information. The “time stamp” is a date and time at which the operation management information is obtained. Other information, such as “RSSI” and “LQ”, are performance values obtained from each device.

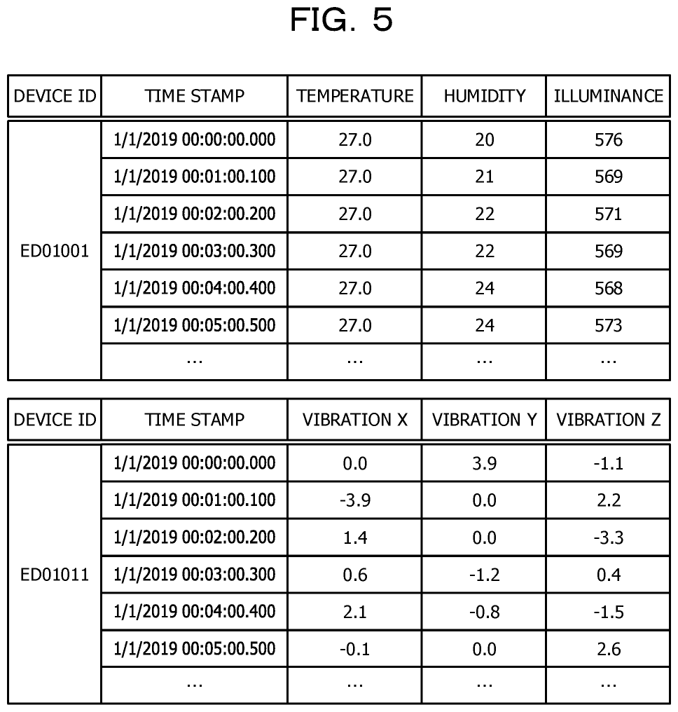

The sensor measurement value obtainment unit 13 receives data (a sensor measurement value) measured by the sensor 72 from the sensor node 70. The sensor measurement value obtainment unit 13 stores the received sensor measurement value in the measurement value DB 32. As illustrated in FIG. 5, in the measurement value DB 32, “device ID” and “time stamp” are managed in the same manner as the operation management information DB 30, and various sensor measurement values (“temperature”, “humidity”, “vibration”, and the like) are managed. In a case where the measurement value DB 32 is updated, the sensor measurement value obtainment unit 13 notifies the abnormality existence determination unit 14 of the update of the measurement value DB 32.

When receiving the update notification of the measurement value DB 32 from the sensor measurement value obtainment unit 13 or receiving the update notification of the operation management information DB 30 from the operation management information obtainment unit 12, the abnormality existence determination unit 14 executes an abnormality existence determination process. For example, the abnormality existence determination unit 14 obtains the latest data from the measurement value DB 32 or the operation management information DB 30, and determines whether or not there is an abnormality. When detecting occurrence of an abnormality, the abnormality existence determination unit 14 estimates a failure type based on an abnormality content.

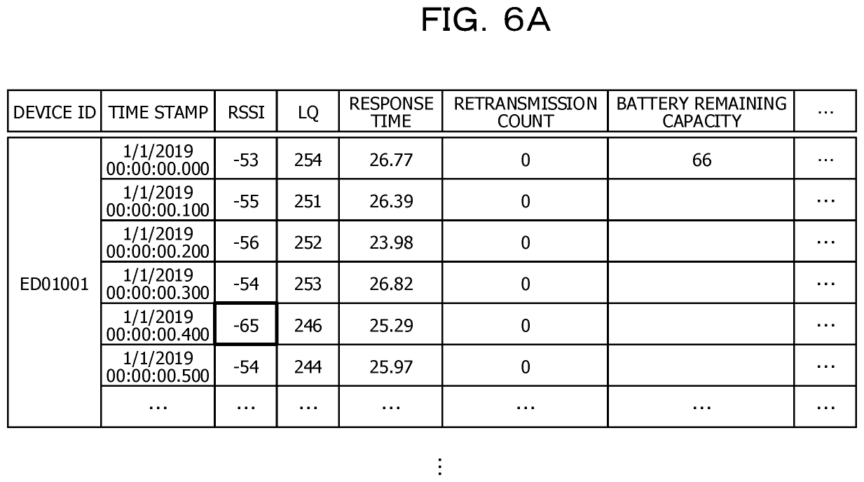

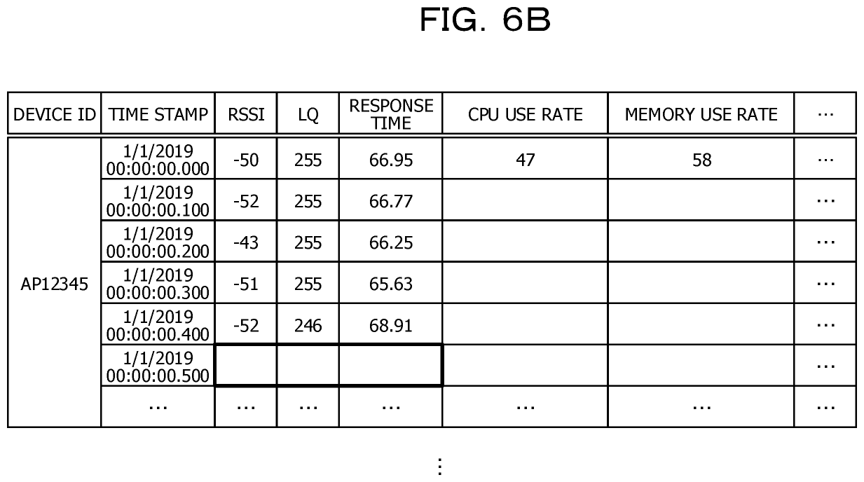

For example, in a case where there is a failure in obtaining a sensor measurement value or operation management information (a data loss), a threshold value of the operation management information is exceeded, or an error message is received, the abnormality existence determination unit 14 detects (determines) that an abnormality occurs. For example, in a case where an RSSI value is less than a threshold value (for example, −60) as illustrated in the thick frame in FIG. 6A, or in a case where an RSSI, an LQ, and a response time are not obtained as illustrated in the thick frame illustrated in FIG. 6B, the abnormality existence determination unit 14 detects that an abnormality occurs. The abnormality existence determination unit 14 may calculate an average value or a variance value from a plurality of extracted latest sensor measurement values and operation management information, and determine occurrence of an abnormality depending on whether or not the calculated average value or variance value exceeds a threshold value (see, for example, International Publication Pamphlet No. WO 2018/066041).

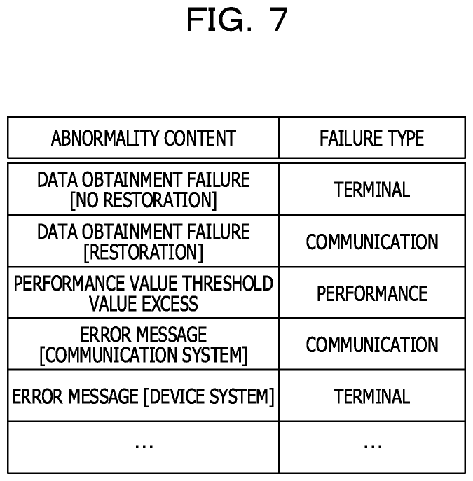

In a case where the failure type is estimated, the abnormality existence determination unit 14 refers to an abnormality content and failure type correspondence table as illustrated in FIG. 7. In the abnormality content and failure type correspondence table, an abnormality content and a failure type are associated with each other. For example, according to the abnormality content and failure type correspondence table, in a case where an abnormality content when an abnormality is detected is a data obtainment failure and there is no spontaneous restoration after that, it is possible to estimate that a failure type is “terminal”. According to the abnormality content and failure type correspondence table, for example, in a case where the abnormality content when the abnormality is detected is a data obtainment failure and there is a spontaneous restoration, it is possible to estimate that the failure type is “communication”. According to the abnormality content and failure type correspondence table, for example, in a case where the abnormality content is that a performance value exceeds a threshold value, it is possible to estimate that the failure type is one corresponding to the performance value. For example, when the performance value exceeding the threshold value is an RSSI or an LQ, the failure type may be estimated as “communication”, and when the performance value exceeding the threshold value is a CPU use rate or a memory use rate, the failure type may be estimated as “terminal”.

When the abnormality occurrence is detected and the failure type is estimated, the abnormality existence determination unit 14 notifies the failure cause specification unit 15 of source data (a device ID, a time stamp, a data name, and a data value) determined to have abnormality occurrence. The abnormality existence determination unit 14 notifies the parameter change requirement determination unit 16 of the estimated failure type.

For example, in a case where the failure type is estimated as “communication” from the data in FIG. 6A, the abnormality existence determination unit 14 notifies the failure cause specification unit 15 of the source data (device ID=“ED01001”, time stamp=“2019/1/1 00:00:00.400”, data name=“RSSI”, and data value=“−65”) determined to have abnormality occurrence. The abnormality existence determination unit 14 notifies the parameter change requirement determination unit 16 of the failure type=“communication”.

For example, in a case where the failure type is estimated as “communication” from the data in FIG. 6B, the abnormality existence determination unit 14 notifies the failure cause specification unit 15 of the source data (device ID=“AP12345”, time stamp=“2019/1/1 00:00:00.500”, data name=“RSSI”, “LQ”, and “response time”, and data value=“null”) determined to have abnormality occurrence. The abnormality existence determination unit 14 notifies the parameter change requirement determination unit 16 of the failure type=“communication”.

Returning to FIG. 3, when receiving the notification when the abnormality occurrence is detected from the abnormality existence determination unit 14, the failure cause specification unit 15 obtains one or more pieces of the latest data of the notified time stamp of the notified device ID, from the operation management information DB 30. The failure cause specification unit 15 analyzes the obtained information by using a parameter for analysis registered in the parameter management DB 34 so as to determine a failure cause. In a case where the failure cause is determined, the failure cause specification unit 15 notifies the notification unit 18 and the parameter change requirement determination unit 16 of information on the failure cause (a device ID, a failure occurrence date and time, and a failure cause).

It is possible to use various analysis methods for analysis of the failure cause. For example, as the analysis method, an average value, a median value, a variance value, or the like may be used, or a comparison of a feature amount or existence of excess of a threshold value may be used. A cluster analysis or a trend analysis and a learning pattern at the time of a normal time or comparison with a cluster may be used. Examples of the cluster analysis include a K-Means method, an X-Means method, and the like. The trend analysis includes, for example, a least squares method, an approximate first order straight line, and the like (see, for example, Japanese Laid-open Patent Publication No. 2017-123124, International Publication Pamphlet No. WO 2018/066041).

Since a manufacturing line is often changed in the manufacturing factory, there are many cases where used sensor nodes may perform communication in a wireless manner. In such a sensor node capable of performing wireless communication, a communication failure such as “radio shielding” by a large apparatus or “radio interference” from the surroundings may be specified as a failure cause. In a case where an inexpensive sensor node or a gateway device for data concentration is used, a failure caused by a terminal, such as insufficient specification of hardware or software (such as “CPU load”, “HDD shortage”, or the like) or “failure”, may be specified as a failure cause.

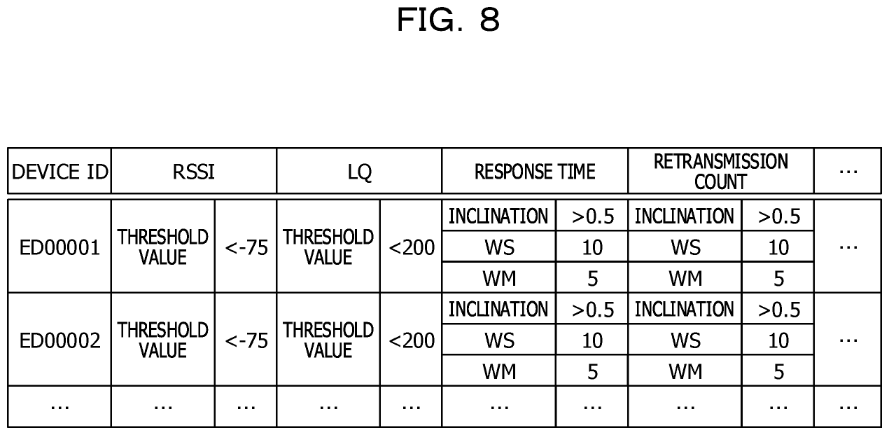

FIG. 8 illustrates an example of a data structure of the parameter management DB 34. As illustrated in FIG. 8, the parameter management DB 34 stores information on parameters used for analysis of a failure cause for each combination of a device ID and a data name.

The parameter change requirement determination unit 16 receives a notification (an abnormality existence notification) at the time of abnormality occurrence and an estimated failure type from the abnormality existence determination unit 14. The parameter change requirement determination unit 16 receives a notification of a failure cause from the failure cause specification unit 15. In a case where the notification of the information of the corresponding failure cause is not received within a predetermined period after receiving the abnormality existence notification, the parameter change requirement determination unit 16 notifies the parameter change unit 17 of the abnormality occurrence date and time and the failure type. It is possible to use a default value (for example, 10 minutes) as the predetermined period after the abnormality existence notification is received. Meanwhile, without being limited thereto, a period according to the failure type notified in the abnormality existence notification may be used as the predetermined period. For example, in a case where the failure type is “terminal”, a relatively long time such as one hour may be used and, for example, in a case where the failure type is “communication”, a relatively short time such as one minute may be used. In this manner, when the relatively long time is set to the predetermined period in the case where the failure type is “terminal”, in a case where a failure occurs in the terminal, a large amount of data obtained during the relatively long time is not analyzed and a failure cause is not known in many cases. When the relatively short time is set to the predetermined period in the case where the failure type is “communication”, operation management information related to the communication is frequently changed, so that the failure cause may be specified from data obtained in the relatively short time in many cases.

In the example described above, the parameter change requirement determination unit 16 determines whether or not the notification of the corresponding failure cause is received within the predetermined period after the abnormality existence notification is received, but is not limited thereto. For example, the parameter change requirement determination unit 16 may determine whether or not the notification of the information on the corresponding failure cause is received within a predetermined period before and after the abnormality existence notification is received.

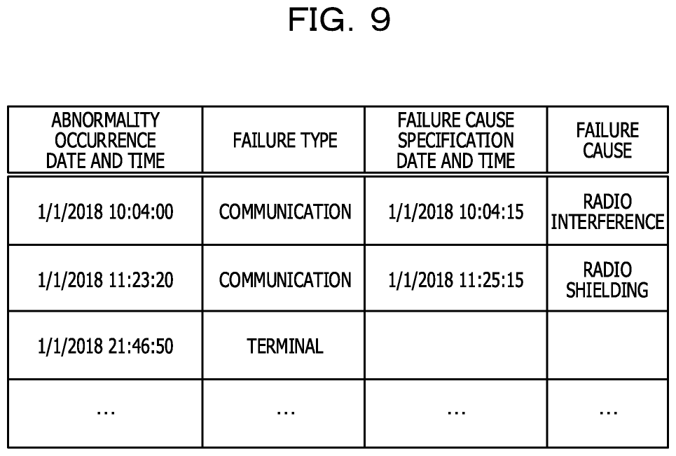

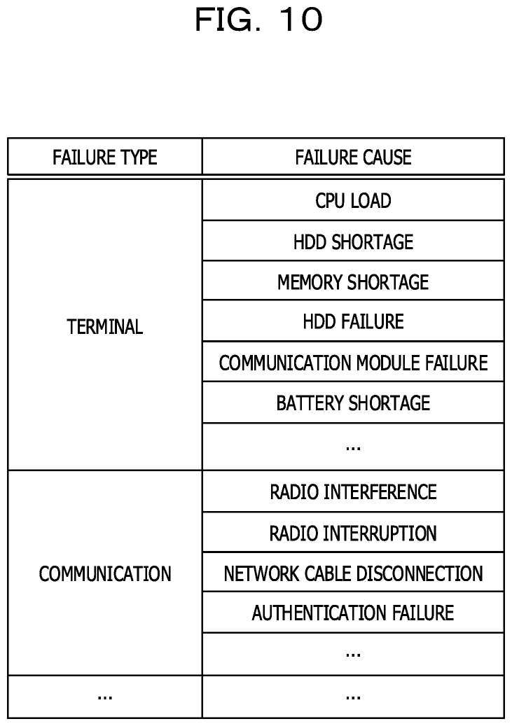

FIG. 9 illustrates an abnormality and failure cause specification correspondence table managed by the parameter change requirement determination unit 16. When an abnormality occurrence date and time and a failure type are notified from the abnormality existence determination unit 14, the parameter change requirement determination unit 16 stores the abnormality occurrence date and time and the failure type in the abnormality and failure cause specification correspondence table. When a failure cause is notified from the failure cause specification unit 15 during a predetermined time based on the stored abnormality occurrence date and time as a reference, the parameter change requirement determination unit 16 stores information on a failure cause specification date and time and the failure cause in the corresponding row. In a case where the failure cause is not input within the predetermined time or in a case where the failure cause is input within the predetermined time, but the failure type and the failure cause do not correspond to each other, the parameter change requirement determination unit 16 notifies the parameter change unit 17 of the abnormality occurrence date and time and the failure type. The parameter change requirement determination unit 16 determines whether or not the failure type and the failure cause correspond to each other, with reference to the failure type and failure cause correspondence table illustrated in FIG. 10. In the failure type and failure cause correspondence table illustrated in FIG. 10, a failure type (a terminal, a communication, . . . ) and a failure cause due to the failure type are associated with each other.

When receiving the notification from the parameter change requirement determination unit 16, the parameter change unit 17 obtains operation management information near the abnormality occurrence date and time from the operation management information DB 30, and changes a parameter for analysis so that the failure cause corresponding to the failure type is specified. Details of the method of changing the parameter for analysis will be described below.

When the parameter is changed, the parameter change unit 17 notifies the failure cause specification unit 15 of a parameter after the change. The failure cause specification unit 15, which receives the notification, registers (updates) the changed parameter in the parameter management DB 34.

When receiving the notification of the information on the failure cause from the failure cause specification unit 15, the notification unit 18 transmits the received information of the failure cause to the server 60, a terminal used by the operation manager, or the like.

(Process of Parameter Change Unit 17)

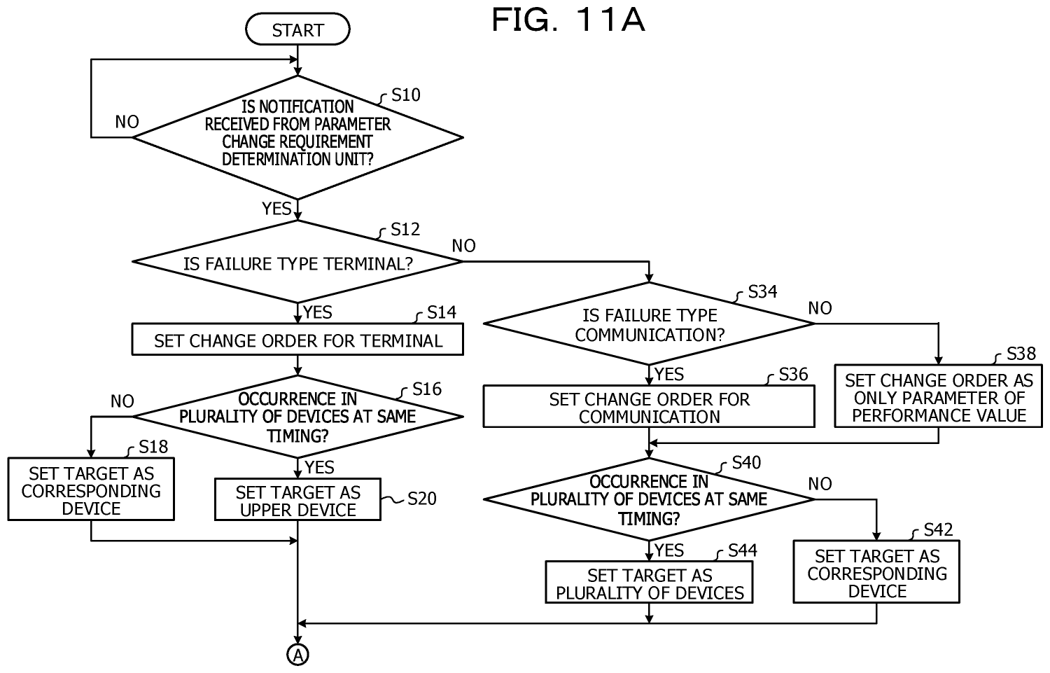

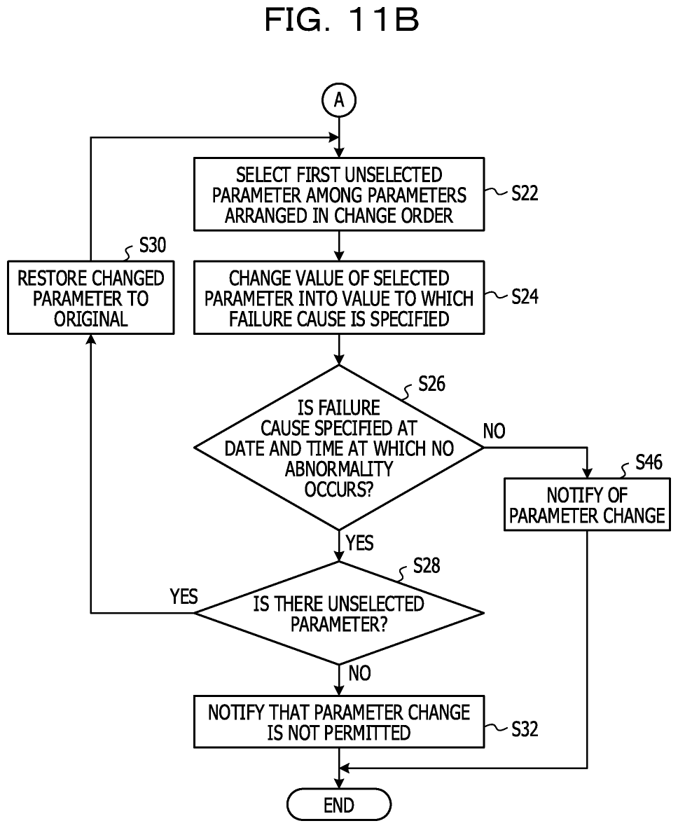

Next, a process of the parameter change unit 17 is described in detail with reference to a flowchart illustrated in FIGS. 11A and 11B and other drawings as appropriate.

When the process in FIGS. 11A and 11B is started, first, in step S10, the parameter change unit 17 waits until the parameter change requirement determination unit 16 receives a notification of an abnormality occurrence date and time and a failure type. As described above, in a case where a failure cause is not input within a predetermined time based on the abnormality occurrence date and time as a reference or in a case where the failure cause is input within the predetermined time, but the failure type and the failure cause do not correspond to each other, the parameter change requirement determination unit 16 performs the notification on the parameter change unit 17.

When receiving the notification, the process is moved to step S12 and the parameter change unit 17 determines whether or not the failure type is “terminal”. In a case where the determination in step S12 is positive, the process is moved to step S14.

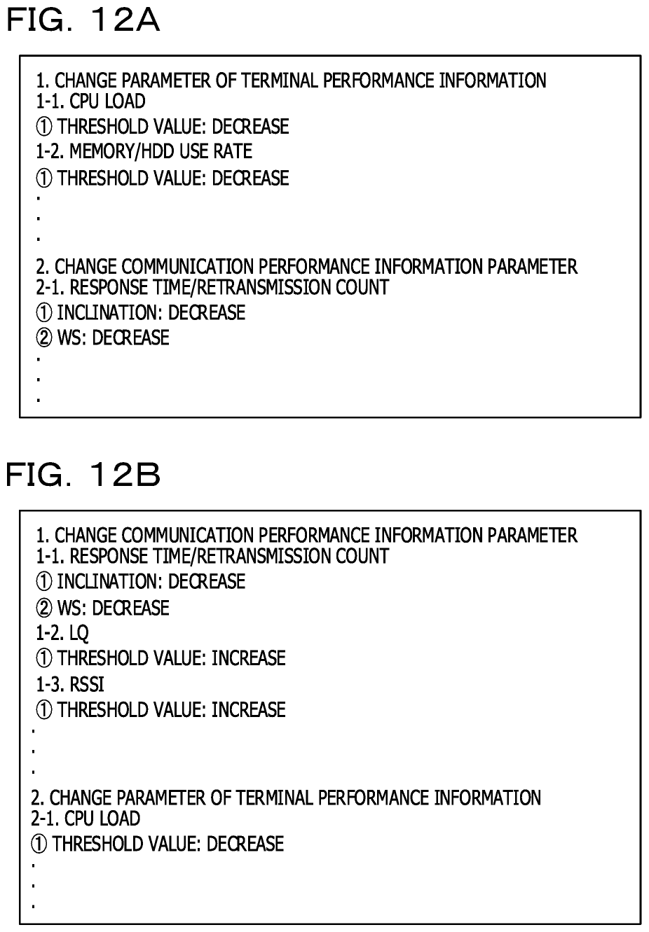

When the process is moved to step S14, the parameter change unit 17 sets a change order for terminal. It is assumed that the change order of parameters includes a change order for terminal as illustrated in FIG. 12A and a change order for communication as illustrated in FIG. 12B. In a case where the failure type is “terminal”, the parameters are changed according to the change order (a priority order) for terminal illustrated in FIG. 12A, so that it is likely to specify an appropriate failure cause. In a case where the failure type is “communication”, the parameters are changed according to the change order (a priority order) for communication illustrated in FIG. 12B, so that it is likely to specify an appropriate failure cause. In step S14, the parameter change unit 17 sets the change order in FIG. 12A to be used in the following manner.

Next, in step S16, the parameter change unit 17 determines whether or not an abnormality occurs in a plurality of devices at the same timing. In a case where the determination in step S16 is negative, for example, in a case where the abnormality occurs in one device, the process is moved to step S18, and a device having a parameter to be changed is regarded as the device in which the abnormality occurs. On the other hand, in a case where the determination in step S16 is positive, for example, in a case where an abnormality occurs in the plurality of devices at the same timing, the process is moved to step S20, and the parameter change unit 17 sets a device having a parameter to be changed as an upper device of the plurality of devices in which the abnormality occurs. In this case, for example, in a case where an abnormality occurs at the same timing in a plurality of sensor nodes 70 coupled to the Wi-Fi access point 130, there is a high possibility that the Wi-Fi access point 130, which is an upper device of the plurality of sensor nodes 70, may have a cause. Therefore, the upper device is set as a target device to be changed in parameter. After the process in step S18 or S20 is executed, the process is moved to step S22.

When the process is moved to step S22, the parameter change unit 17 selects a first unselected parameter from parameters arranged in the change order. For example, in a case where the change order in FIG. 12A is set, the parameter change unit 17 selects “1-1. CPU load”.

Next, in step S24, the parameter change unit 17 changes a value of the selected parameter to a value to which a failure cause is specified. In a case where “1-1. CPU load” is selected, the parameter change unit 17 reduces a threshold value of the CPU load so that the failure cause is specified.

Next, in step S26, the parameter change unit 17 determines whether or not a failure cause is specified in a date and time at which no abnormality occurs as a result of the change in the parameter. For example, the parameter change unit 17 obtains operation management information obtained within a predetermined time based on a failure occurrence date and time from the operation management information DB 30, and specifies the failure cause. As a result, in a case where the failure cause is not newly specified at the date and time at which no abnormality occurs, it means that the parameter change is appropriately performed. In this case, the determination in step S26 is negative, and the process is moved to step S46. In step S46, the parameter change unit 17 notifies the failure cause specification unit 15 of the parameter change, and causes the failure cause specification unit 15 to update the parameter management DB 34. For example, the change in the parameter is confirmed. After that, all the processes in FIGS. 11A and 11B are terminated.

In contrast, in step S26, since the failure cause is newly specified at the date and time at which no abnormality occurs, when the determination is positive, the process is moved to step S28. The case where the process is moved to step S28 means that the parameter change is not appropriate. In step S28, the parameter change unit 17 determines whether or not there is an unselected parameter. When the determination in step S28 is positive, the process is moved to step S30, and the parameter change unit 17 restores the changed parameter to the original parameter and the process is moved to step S22.

When the process is moved to step S22, the parameter change unit 17 selects the next parameter. For example, in a case where the previous “1-1. CPU load” is selected, the parameter change unit 17 selects the next “1-2. memory/HDD use rate”. Thereafter, the process in step S24 and the subsequent processes are repeated. In a case where the determination in step S26 is not negative and the determination in step S28 is negative, the process is moved to step S32. In this case, since it means that the parameter change may not be performed, the parameter change unit 17 notifies the failure cause specification unit 15 that the parameter change is not permitted. The failure cause specification unit 15, which receives the notification, notifies the server 60, a terminal used by the operation manager, or the like, that the parameter change may not be performed, via the notification unit 18.

In a case where the failure type is not the “terminal”, the determination in step S12 is negative, and the process is moved to step S34. When the process is moved to step S34, the parameter change unit 17 determines whether or not the failure type is “communication”. In a case where the determination in step S34 is positive, the process is moved to step S36, and the parameter change unit 17 sets a change order for communication. For example, the parameter change unit 17 sets the change order in FIG. 12B to be used in the following manner.

Next, in step S40, the parameter change unit 17 determines whether or not an abnormality occurs in the plurality of devices at the same timing. In a case where the determination in step S40 is negative, for example, in a case where the abnormality occurs in one device, the process is moved to step S42, and a device having a parameter to be changed is regarded as the device in which the abnormality occurs. On the other hand, in a case where the determination in step S40 is positive, for example, in a case where the abnormality occurs in the plurality of devices at the same timing, the device having the parameter to be changed is regarded as the plurality of devices in which the abnormality occurs at the same timing. In a case where the abnormality related to communication occurs in the plurality of devices at the same timing, there is a high possibility that each device may have a failure cause.

Thereafter, the process is moved to step S22, and the process in step S22 and the subsequent processes are executed as described above. In this case, the parameter change unit 17 changes parameters according to the change order in FIG. 12B.

In a case where the determination in step S34 is negative, for example, in a case where the failure type is “performance”, the process is moved to step S38, and the parameter change unit 17 sets a change order of the parameters as only parameters of the corresponding performance values. Thereafter, the process in step S40 and the subsequent processes are executed in the same manner as described above. In a case where the failure type is the “performance”, there is only one parameter to be changed, and when the determination in step S26 is positive, the process may be moved to step S32 without step S28.

As described above, by executing the processes illustrated in FIGS. 11A and 11B it is possible to appropriately change the parameters for analyzing the failure cause. The processes illustrated in FIGS. 11A and 11B are repeatedly executed.

The flowchart in FIGS. 11A and 11B illustrates the processes in the case where the failure types are three of “terminal”, “communication”, and “performance”. Meanwhile, the present embodiment is not limited to this, and the flowchart in FIGS. 11A and 11B may be appropriately changed in accordance with the number of actual failure types.

As described in detail above, according to the first embodiment, the abnormality existence determination unit 14 detects an abnormality based on operation management information or a sensor measurement value periodically collected from the management target apparatuses such as the sensor node 70 or the router 10, and estimates a failure type from the abnormality content. The failure cause specification unit 15 analyzes the operation management information by using a parameter for analysis so as to specify a failure cause of the management target apparatus. The parameter change requirement determination unit 16 determines whether or not the failure cause corresponding to the failure type is specified within a predetermined time based on the date and time at which the abnormality occurrence is detected. When the corresponding failure cause is not specified as a result of the determination, the parameter change unit 17 changes the parameter for analysis according to the priority order (the change order) of the parameter corresponding to the estimated failure type. Thus, in the present embodiment, even in an IOT environment in which it is unclear what abnormality or failure occurs, it is possible to automatically determine a parameter capable of appropriately specifying a failure cause based on the operation management information collected during the system operation. Therefore, it is possible to specify the failure cause with high accuracy in the IoT environment which changes momentarily. In this case, since the parameters are changed along the change order (FIG. 12A and FIG. 12B) of the parameter according to the estimated failure type, it is possible to efficiently change the parameters in an appropriate order matching the failure type.

In the present embodiment, the parameter change unit 17 changes the parameters for analysis so as to obtain the result of specifying the corresponding failure cause. The parameter change unit 17 analyzes the operation management information obtained in a predetermined period in the past by using the parameter for analysis after the change, and confirms the change in the parameter for analysis when the failure cause is not specified at the date and time at which no abnormality is detected (negative in S26 and S46). Accordingly, it is possible to appropriately perform the parameter change so that a wrong failure cause is not specified.

### Second Embodiment

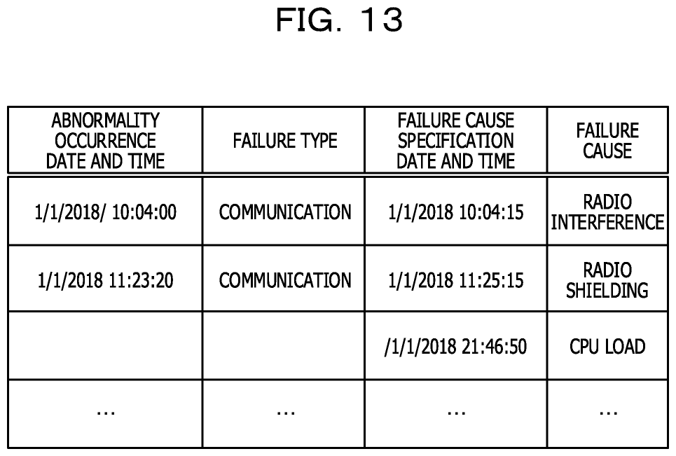

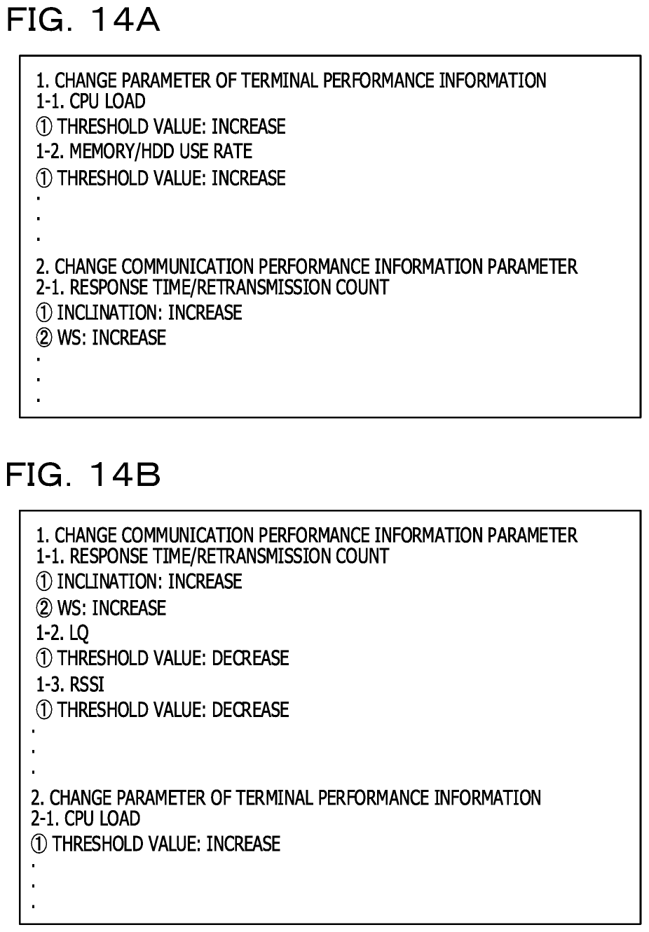

Next, a second embodiment will be described in detail with reference to FIG. 13 to FIG. 14B. In the second embodiment, the failure cause specification unit 15 executes a process of specifying a failure cause at all times. In this case, the failure cause specification unit 15 specifies the failure cause even at a timing when an abnormality is not detected by the abnormality existence determination unit 14. In such a case, it may also be considered that a failure symptom appears at a stage before occurrence of the abnormality.

Meanwhile, in a case where it is not detected that the abnormality occurs even though the same failure cause is determined many times during a short period, there is a high possibility that the failure cause may be erroneously specified. In the second embodiment, the parameter change unit 17 changes a parameter so as to suppress such a failure cause from being erroneously specified.

In the second embodiment, when detecting that the fact an abnormality having a failure type corresponding to a failure cause does not occur is repeated a predetermined number of times or more (for example, 1 times or more), the parameter change requirement determination unit 16 performs notification on the parameter change unit 17. For example, as illustrated in FIG. 13, in a case where there is a row in which the corresponding failure type is not stored for a predetermined period or more although the failure cause is stored in the abnormality and failure cause specification correspondence table, the parameter change requirement determination unit 16 performs the notification on the parameter change unit 17.

The predetermined period may be a default value (for example, one hour), or a different value according to the failure type corresponding to the failure cause may be used. For example, in a case where the failure type corresponding to the failure cause is “terminal”, for example, a relatively long time such as 2 hours or the like may be set as the predetermined period, and in a case where the failure type corresponding to the failure cause is “communication”, for example, a relatively short time such as 30 minutes or the like may be set as the predetermined period. The reason why the predetermined times are different between the case where the failure type corresponding to the failure cause is “terminal” and the case where the failure type is “communication” is described in the first embodiment described above. The predetermined period may be a time after receiving a failure cause, or may be a time before or after the failure cause.

The predetermined number of times is not limited to one, and may be two, three, or the like. The predetermined number of times may be different depending on the failure type corresponding to the failure cause. For example, in a case where the failure type corresponding to the failure cause is “terminal”, a relatively small number of times (for example, one time) may be used, and in a case where the failure type corresponding to the failure cause is “communication”, a relatively large number of times (for example, 5 times) may be used. In this manner, the predetermined number of times may be set to an appropriate value in consideration of the output of the failure symptom corresponding to the failure type.

In the same manner as the first embodiment, the parameter change unit 17 executes processes in accordance with the flowchart in FIGS. 11A and 11B. In steps S12 and S34, it is determined whether the failure type is a terminal or communication, but in the second embodiment, the failure type is not estimated. Therefore, the parameter change unit 17 specifies the failure type corresponding to the specified failure cause based on the failure type and failure cause correspondence table in FIG. 10. Based on the specified failure type, steps S12 and S34 are executed. In the second embodiment, it is assumed that a change order for terminal is in the order illustrated in FIG. 14A, and a change order for communication is in the order illustrated in FIG. 14B.

In FIG. 14A and FIG. 12A, the change orders are the same, but whether the parameters (threshold values and the like) are decreased or increased is opposite to each other. The same applies to FIG. 14B and FIG. 12B, and whether the parameters (the threshold values and the like) are increased or decreased is opposite to each other.

In the first embodiment, in step S26 in FIG. 11B, the parameter change unit 17 determines whether or not a failure cause at a date and time at which no abnormality occurs within a predetermined time in the past is specified, as a result of a change in parameters. In contrast, in the second embodiment, the parameter change unit 17 determines whether or not a failure cause is not specified in a date and time at which an abnormality occurs in a predetermined time in the past, as a result of a change in parameters. In this manner, in a case where the failure cause is not specified as a result of the change in the parameter, it is possible not to adopt the parameter being changed.

As described in detail above, according to the second embodiment, the abnormality existence determination unit 14 detects abnormality occurrence based on operation management information or a sensor measurement value periodically collected from the management target apparatuses such as the sensor node 70 or the router 10, and estimates a failure type from the abnormality content. The failure cause specification unit 15 analyzes the operation management information by using a parameter for analysis so as to specify a failure cause of the management target apparatus. The parameter change requirement determination unit 16 determines whether or not a failure type corresponding to the failure cause is estimated within a predetermined time based on a timing at which the failure cause is specified. When the corresponding failure type is not estimated as a result of the determination, the parameter change unit 17 changes a parameter for analysis according to the priority order of the parameter according to the failure type corresponding to the failure cause. Thus, even in an IOT environment in which it is unclear what abnormality or failure occurs, it is possible to automatically determine a parameter capable of appropriately specifying a failure cause based on the operation management information collected during the system operation. Therefore, it is possible to specify the failure cause with high accuracy in the IoT environment which changes momentarily. In this case, since the parameters are changed along the change order (FIG. 14A and FIG. 14B) of the parameter according to the failure type corresponding to the specified failure cause, it is possible to efficiently change the parameters in an appropriate order matching the failure type.

### Third Embodiment

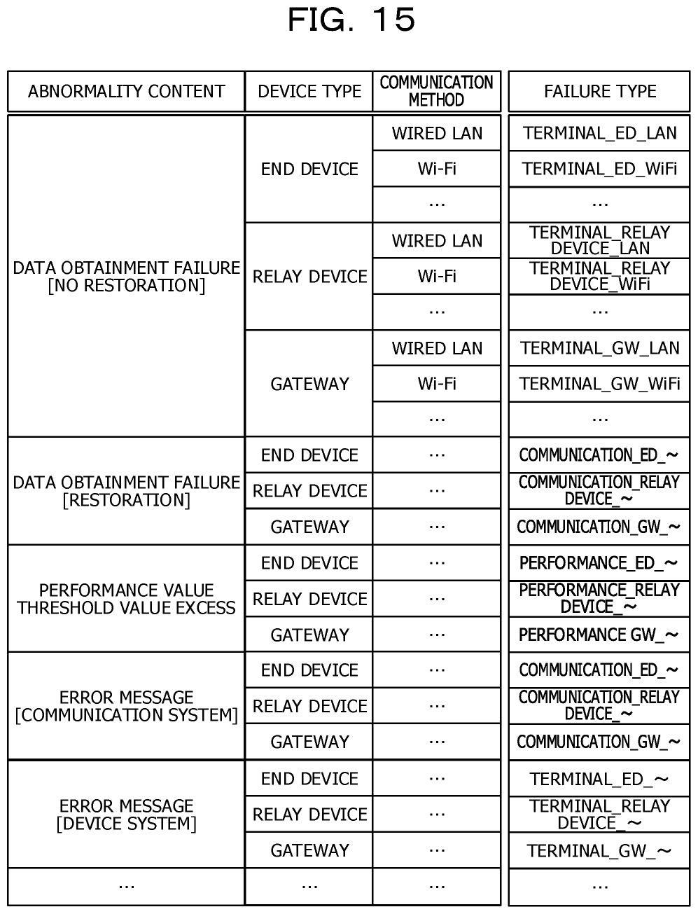

Hereinafter, a third embodiment will be described based on FIG. 15. In the first and second embodiments described above, the case where the abnormality content and failure type correspondence table used by the abnormality existence determination unit 14 is the table as illustrated in FIG. 7 is described, but in the present embodiment, the abnormality content and failure type correspondence table as illustrated in FIG. 15 is used.

Although the abnormality content and failure type correspondence table illustrated in FIG. 7 stores abnormal types in association with abnormality contents, in the abnormality content and failure type correspondence table (FIG. 15) according to the third embodiment, a failure type is defined in associated with a combination of an abnormality content, a device type, and a communication method. For example, the abnormality content is classified by the device type (an end device, a relay device, and a gateway) and the communication method (a wired LAN, Wi-Fi, . . . ), and a failure type is determined in each case. It is assumed that subdivided failure types in the same manner as in FIG. 15 are used for a correspondence table other than FIG. 15 used in the third embodiment. In this manner, by subdividing and defining the failure type, it becomes possible to perform the failure cause determination more accurately.

As described above, according to the third embodiment, since the failure type is determined based on the abnormality content, the device type, and the communication method, the failure determination may be performed with higher accuracy.

### Fourth Embodiment

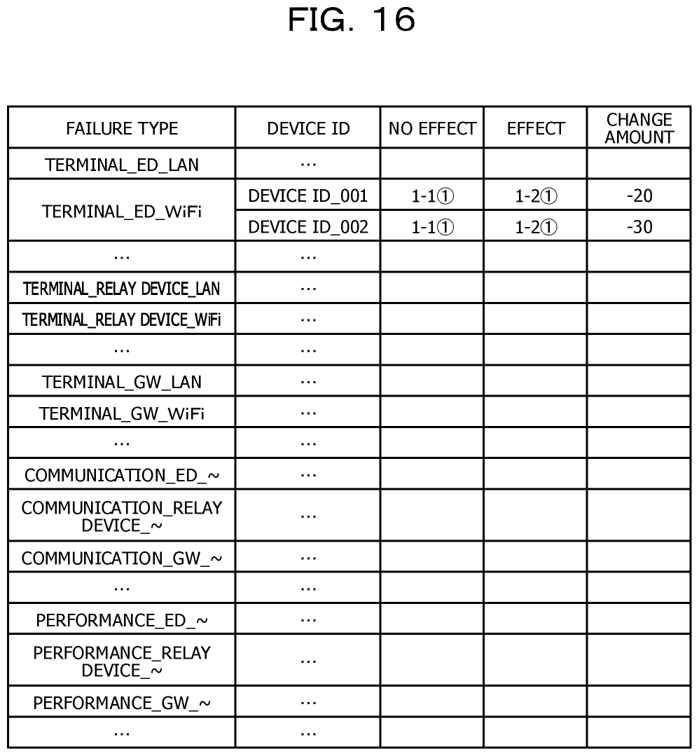

Next, a fourth embodiment will be described with reference to FIG. 16. In the fourth embodiment, in a case where the parameter change unit 17 changes the parameters in the first embodiment, a history of an effect of the change is recorded, and a change order of the parameters is adjusted based on the history of the effect of the change.

In the fourth embodiment, as an example, the abnormality existence determination unit 14 uses the failure content and failure type correspondence table described in the third embodiment. For this reason, the abnormality existence determination unit 14 estimates subdivided failure types as illustrated in FIG. 15. The process of the parameter change unit 17 is the same as that of the first embodiment described above (FIGS. 11A and 11B).

In the fourth embodiment, the parameter change unit 17 updates the effect management table illustrated in FIG. 16 when the parameter change is notified to the failure cause specification unit 15 in step S46 and when the changed parameter is restored to the original state in step S30 in FIG. 11B.

In the effect management table of FIG. 16, a parameter change of “no effect”, a parameter change of “effective”, and a parameter “change amount” when there is an effect are stored for each combination of a failure type and a device ID. For example, in a case where the process in step S30 is performed, the parameter change unit 17 stores information of the parameters restored to the original state (a number of the parameter in FIG. 12A and FIG. 12B) in a corresponding field of “no effect”. In a case where the process in step S46 is performed, the parameter change unit 17 stores the information of the changed parameter (a number of the parameter in FIG. 12A and FIG. 12B) in a corresponding field of “effective”, and stores a change amount of the parameter in a field of “change amount”.

In the same failure type, the parameter change unit 17 updates the change order in FIG. 12A and FIG. 12B so as to increase a priority order (the change order) of the parameter of “effective” in a case where the parameter of “effective” is common to each device. Thus, by using the change order (FIG. 12A and FIG. 12B) generated based on the result of learning which parameter is to be preferentially changed, a parameter having a high change effect may be changed preferentially, so that it is possible to efficiently change the parameter.

In a case where the “change amount” of each device is common for the same failure type, the common change amount may be defined in the change order (FIG. 12A and FIG. 12B). In the same failure type, when “change amount” of each device is not common, a minimum value among pieces of “change amount” of the devices in the same failure type may be defined in the change order (FIG. 12A and FIG. 12B), or an average value of pieces of “change amount” may be defined in the change order.

When a change amount is defined in FIGS. 12A and 12B, the change amount may be defined for each time zone, or the change amount may be defined for each weekday/holiday or may be defined for each day of the week.

In a case where a failure type is related to “terminal” and a parameter change which has the effect is “communication performance information”, the parameter change unit 17 may notify the abnormality existence determination unit 14 to change the failure type to be related to “communication”. In the same manner, in a case where the failure type is related to “communication” and the parameter change which has the effect is “terminal performance information”, the parameter change unit 17 may notify the abnormality existence determination unit 14 to change the failure type to be related to “terminal”.

In the fourth embodiment, a case where a history of the effect of changing the parameters is recorded in the effect management table (FIG. 16) in the first embodiment, and the change order in FIG. 12A and FIG. 12B is changed based on the effect management table is described. Meanwhile, the present embodiment is not limited thereto, and the history of the effect of changing the parameters may be recorded in the effect management table (FIG. 16) in the second embodiment, and the change order in FIG. 14A and FIG. 14B may be changed based on the effect management table.

In the above embodiments, the server 60 may have the function of the gateway 110 illustrated in FIG. 3. The function of the gateway 110 of FIG. 3 may be shared by a plurality of devices.

In the above embodiments, the parameter change unit 17 performs the processes in FIGS. 11A and 11B when changing the parameter for analysis, but the present embodiment is not limited thereto. When generating the learning model used in the machine learning, the parameter change unit 17 may change the parameters used for applying a normality/abnormality label to the collected data according to the processes illustrated in FIGS. 11A and 11B. For example, the learning model may be changed by the processes illustrated in FIGS. 11A and 11B.

The above-described processing functions may be realized by a computer. In this case, there is provided a program in which the processing contents of the functions which a processing device is supposed to have are described. The above-described processing functions are realized in the computer when the computer executes the program. The program in which the processing contents are described may be recorded in a computer-readable storage medium (except for a carrier wave).

To distribute the program, a portable storage medium such as a digital versatile disc (DVD), a compact disc read-only memory (CD-ROM), or the like storing the program is marketed, for example. The program may be stored in a storage device of a server computer and transferred from the server computer to another computer through a network.

For example, the computer which executes the program stores the program recorded in the portable storage medium or the program transferred from the server computer in the storage device of the computer. The computer reads the program from the storage device thereof and executes processes in accordance with the program. The computer may read the program directly from the portable storage medium and execute the processes in accordance with the program. Every time the program is transferred from the server computer to the computer, the computer may sequentially execute the processes in accordance with the program.

The above-described embodiment is an example of a preferred embodiment. Meanwhile, the embodiment is not limited thereto, and various modifications may be made without departing from the spirit of the present disclosure.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing method executed by a computer, the information processing method comprising:
detecting occurrence of an abnormality based on information including operation management information related to performance of a management target apparatus periodically collected from the management target apparatus;
estimating a type of a failure based on contents of the abnormality;
analyzing the operation management information by using a parameter for analysis to specify a cause of the failure of the management target apparatus;
determining whether the cause corresponding to the estimated type is specified or whether the type corresponding to the specified cause is estimated; and
changing the parameter for analysis according to a priority order of a parameter corresponding to the estimated type or the specified cause when the cause corresponding to the estimated type is not specified or the type corresponding to the specified cause is not estimated as a result of the determination.

2. The information processing method according to claim 1,
wherein the determining includes determining whether a timing of detecting the occurrence of the abnormality and a timing of specifying the cause are matched, and whether the specified cause causes the estimated type.

3. The information processing method according to claim 1, wherein the changing includes:
changing the parameter for analysis so that the cause corresponding to the estimated type is specified or the type corresponding to the specified cause is estimated, and
confirming the change of the parameter for the analysis when there is no change in results of detecting abnormality occurrence in the past and specifying a failure cause in the past, by using the parameter for analysis after the change.

4. The information processing method according to claim 1, further comprising:
storing information on an effect exhibited by changing the parameter for analysis in the changing; and
determining the priority order based on the stored information.

5. An information processing apparatus comprising:
a memory; and
a processor coupled to the memory and the processor configured to:
detect occurrence of an abnormality based on information including operation management information related to performance of a management target apparatus periodically collected from the management target apparatus,
estimate a type of a failure based on contents of the abnormality,
analyze the operation management information by using a parameter for analysis to specify a cause of the failure of the management target apparatus,
determine whether the cause corresponding to the estimated type is specified or whether the type corresponding to the specified cause is estimated, and
change the parameter for analysis according to a priority order of a parameter corresponding to the estimated type or the specified cause when the cause corresponding to the estimated type is not specified or the type corresponding to the specified cause is not estimated as a result of the determination.

6. The information processing apparatus according to claim 5, wherein the processor is configured to
determine whether a timing of detecting the occurrence of the abnormality and a timing of specifying the cause are matched, and whether the specified cause causes the estimated type.

7. The information processing apparatus according to claim 5, wherein the processor is configured to:
change the parameter for analysis so that the cause corresponding to the estimated type is specified or the type corresponding to the specified cause is estimated, and
confirm the change of the parameter for the analysis when there is no change in results of detecting abnormality occurrence in the past and specifying a failure cause in the past, by using the parameter for analysis after the change.

8. The information processing apparatus according to claim 5, wherein the processor is configured to:
store information on an effect exhibited by changing the parameter for analysis in the changing, and
determine the priority order based on the stored information.
